(19) United States
(12) Patent Application Publication
(10) Pub. No.: US 2026/0115094 A1
(43) Pub. Date: Apr. 30, 2026

(54) WEARABLE MASSAGER

(71) Applicant: Jing YUAN, Shenzhen (CN)

(72) Inventor: Jing YUAN, Shenzhen (CN)

(21) Appl. No.: 19/000,917

(22) Filed: Dec. 24, 2024

(30) Foreign Application Priority Data
Oct. 25, 2024 (CN) 202422589810.7

(51) Int. Cl. A61H 23/02

(52) U.S. Cl. CPC A61H 23/0254; A61H 2201/0153; A61H 2201/1215

(57) ABSTRACT

The present disclosure relates to a wearable massager, which belongs to the field of massage equipment and comprises a rod-shaped body. One end of the body is a handle and the other end is a massage head; a middle branch of the body forms a massage collar, the handle is embedded with a circuit board and a power supply, the massage head is embedded with a massage module, the middle branch of the body is embedded with a first vibration motor, and the circuit board, the massage module, the first vibration motor and a power supply circuit are connected to form a closed circuit.

### CROSS-REFERENCE TO RELATED APPLICATIONS

The application claims priority to Chinese patent application No. 202422589810.7, filed on Oct. 25, 2024, the entire contents of which are incorporated herein by reference.

### TECHNICAL FIELD

The present disclosure relates to a massager, in particular to a wearable massager, which belongs to the field of massage equipment.

### BACKGROUND

After working or laboring for a long time, people's muscles are prone to fatigue and need proper rest for recovery. However, it often takes a period of time to recover by relying on the human body itself. Therefore, massagers have been developed in the prior art to accelerate lactic acid decomposition and shorten recovery time.

A massager generally stimulates and massages muscles or acupoints through vibration to relieve muscle soreness and eliminate fatigue. In addition, the massager can also release pressure and calm emotions, which is conducive to physical and mental health. However, most of the massagers in the prior art are large in size, such as massage chairs, massage pillows, massage lumbar supports, etc., which are not convenient to use, while small-sized massagers, such as fascia guns, although convenient to carry, still need to be held with one hand when using. In addition, massagers in the prior art are featured with a fixed shape and a single use mode.

### SUMMARY

In view of this, the present disclosure provides a wearable massager, which can be conveniently used by covering a user's arm and other positions with a massage collar to solve the above problems existing in the prior art.

The technical solution of the present disclosure for solving the above-mentioned technical problem is as follows:

A wearable massager comprises a stick-shaped body, one end of the body is a handle and the other end is a massage head. The middle branch of the body forms a massage collar, the handle is embedded with a circuit board and a power supply, the massage head is embedded with a massage module, the middle branch of the body is embedded with a first vibration motor, and the circuit board, the massage module, the first vibration motor and a power supply circuit are connected to form a closed circuit.

On the basis of the above technical solution, the present disclosure can be further improved as follows.

Further, the massage module includes a driving motor and a second vibration motor connected to the driving motor through a connecting rod.

Further, the massage collar is of a flexible material;

Further, the flexible material is silica gel.

Further, the massage head is spherical.

Further, the circuit board extends to the handle to form a button.

Further, the power supply is a rechargeable power supply, and the power supply extends to the handle to form a charging socket.

The present disclosure has the following beneficial effects: a wearable massage collar is added on the basis of the traditional stick-shaped massager, and the shape of the massager can be changed by removing the massage collar from the main body and sleeving it on the user's arm or other parts, so that massage can be carried out without holding it in hand, which can meet the massage requirements of different parts.

### BRIEF DESCRIPTION OF DRAWINGS

FIG. 1 is a structural schematic diagram of the wearable massager according to the present disclosure;

FIG. 2 is a sectional view of the structure of the wearable massager according to the present disclosure;

FIG. 3 is a structural schematic diagram of the present disclosure;

FIG. 4 is a structural schematic diagram of the first vibration motor according to the present disclosure.

In the drawings, the parts represented by reference numbers are listed below:

1. handle, 2. massage head, 3. massage collar, 4. circuit board, 5. power supply, 6. massage module, 7. first vibration motor, 8. button, 9. charging socket.

### DETAILED DESCRIPTION OF THE EMBODIMENTS

The principles and features of the present disclosure are described below with reference to the drawings. Examples given herein are only for explaining the present disclosure, not for limiting the scope of the present disclosure.

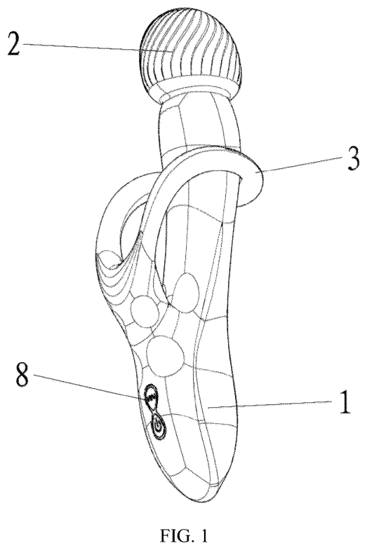

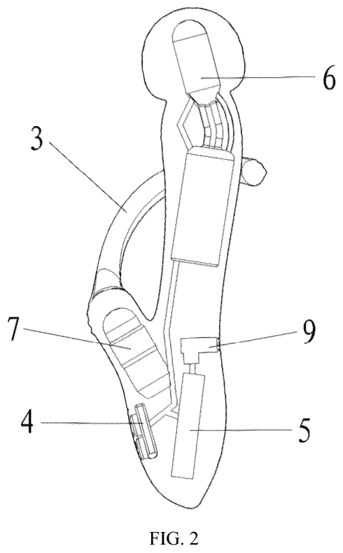

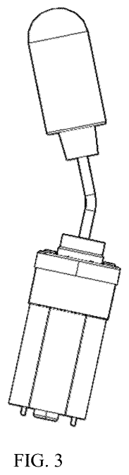

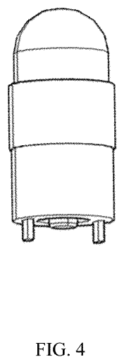

As shown in FIGS. 1-4, a wearable massager comprises a stick-shaped body, one end of the body is a handle 1 and the other end is a massage head 2. The middle branch of the body forms a massage collar 3, the handle 1 is embedded with a circuit board 4 and a power supply 5, the massage head 2 is embedded with a massage module 6, the middle branch of the body is embedded with a first vibration motor 7, and the circuit board 4, the massage module 6, the first vibration motor 7 and a power supply 5 circuit are connected to form a closed circuit.

When in use, the massage collar 3 can be sleeved on the body for use, that is, the massager is held by hand and the massage head 2 is used to massage acupoints or muscles. The usage method is the same as that of the traditional stick-shaped massager. The massage collar 3 can be removed and sleeved on the arm, wrist, ankle and other parts for massage through the first vibration motor 7.

In another embodiment of the present disclosure, the massage module 6 comprises a driving motor and a second vibration motor connected with the driving motor through a connecting rod. The second vibration motor provides vibrating massage, and the driving motor is used to adjust the direction and drive the massage head to reciprocate or rotate.

In another embodiment of the present disclosure, the massage collar 3 is of a flexible material.

The flexible material is silica gel.

In another embodiment of the present disclosure, the massage head 2 is spherical.

In another embodiment of the present disclosure, the circuit board 4 extends to the handle 1 to form a button 8.

In another embodiment of the present disclosure, the power supply 5 is a rechargeable power supply 5, and the power supply 5 extends to the handle 1 to form a charging socket 9.

The above are only preferred embodiments of the present disclosure and are not intended to limit the present disclosure. Any modifications, equivalents, improvements made within the spirit and principles of the present disclosure shall fall within the scope of protection of the present disclosure.

What is claimed is:

1. A wearable massager, comprising a stick-shaped body, wherein one end of the body is a handle and the other end is a massage head; a middle branch of the body forms a massage collar, the handle is embedded with a circuit board and a power supply, the massage head is embedded with a massage module, the middle branch of the body is embedded with a first vibration motor, and the circuit board, the massage module, the first vibration motor and a power supply circuit are connected to form a closed circuit.

2. The wearable massager according to claim 1, wherein the massage module comprises a driving motor and a second vibration motor connected with the driving motor through a connecting rod.

3. The wearable massager according to claim 1, wherein the massage collar is of a flexible material.

4. The wearable massager according to claim 3, wherein the flexible material is silica gel.

5. The wearable massager according to claim 1, wherein the massage head is spherical.

6. The wearable massager according to claim 1, wherein the circuit board extends to the handle to form a button.

7. The wearable massager according to claim 1, wherein the power supply is a rechargeable power supply, and the power supply extends to the handle to form a charging socket.
